(19) United States
(12) Patent Application Publication
(10) Pub. No.: US 2014/0165652 A1
(43) Pub. Date: Jun. 19, 2014

(54) CUTTING METHOD FOR REINFORCED GLASS PLATE AND REINFORCED GLASS PLATE CUTTING DEVICE

(71) Applicant: Asahi Glass Company, Limited, Chiyoda-ku (JP)

(72) Inventor: Isao SAITO, Tokyo (JP)

(73) Assignee: Asahi Glass Company, Limited, Chiyoda-ku (JP)

(21) Appl. No.: 14/188,879

(22) Filed: Feb. 25, 2014

Related U.S. Application Data
(63) Continuation of application No. PCT/JP2012/071356, filed on Aug. 23, 2012.

(30) Foreign Application Priority Data
Aug. 29, 2011 (JP) 2011-185833

(51) Int. Cl. C03B 33/04; C03B 33/09

(52) U.S. Cl. CPC C03B 33/04; C03B 33/091
USPC 65/28; 65/29.11; 65/112; 65/163

(57) ABSTRACT

The invention relates to a method for cutting a strengthened glass sheet in which, when a strengthened glass sheet 10 including a front surface layer 13 and a rear surface layer 15 which have a residual compressive stress, and an intermediate layer 17 which has an inside residual tensile stress, is cut by moving an irradiation region 22 of a laser beam so as to have a predetermined curvature radius, an irradiation energy per unit irradiation area of a laser beam 20 to be irradiated on the strengthened glass sheet 10 is increased as a curvature radius decreases. Thereby, it is possible to cut a strengthened glass sheet using a laser beam without causing a deterioration of quality.

### TECHNICAL FIELD

The present invention relates to a method for cutting a strengthened glass sheet and an apparatus for cutting a strengthened glass sheet.

### BACKGROUND ART

Recently, in order to improve the protection, appearance and the like of displays (including touch panels), cover glass (protective glass) has been frequently used in mobile devices such as mobile phones or PDAs. In addition, glass substrates are widely used as substrates for displays.

Meanwhile, due to the continuous decrease in the thickness and weight of mobile devices, the thickness of glass sheets being used in mobile devices is also continuously decreased. Since the decrease in the thickness of a glass leads to a decrease in the strength of the glass, strengthened glass including a front surface layer and a rear surface layer in which a compressive stress remains has been developed to compensate for the lack of the strength of glass. The strengthened glass is also used for vehicle window glass and building window glass.

The strengthened glass is produced using, for example, a thermal-tempering-by-air-jets method, a chemical strengthening method or the like. In the thermal-tempering-by-air-jets method, glass having a temperature near the softening point is quenched from the front surface and the rear surface so as to create a temperature difference between the front surface, the rear surface and the inside of the glass, thereby forming a front surface layer and a rear surface layer in which a compressive stress remains. Meanwhile, in the chemical strengthening method, the front and rear surfaces of the glass are ion-exchanged so as to substitute ions with a small ion radius (for example, Li ion and Na ion), which are included in the glass, by ions with a large ion radius (for example, K ion), thereby forming a front surface layer and a rear surface layer in which a compressive stress remains. In both methods, an intermediate layer in which a tensile stress remains is formed between the front surface layer and the rear surface layer as a counteraction.

In a case of manufacturing the strengthened glass, it is more effective to strengthen a glass which is larger than a target product and then cut the glass into multiple pieces than to strengthen glasses having the same size as the target product one by one. Therefore, as a method for cutting a strengthened glass sheet, a method of cutting a strengthened glass by irradiating a laser beam on the surface of the strengthened glass sheet and moving an irradiation region of the laser beam on the surface of the strengthened glass sheet has been proposed (refer to Patent Documents 1 and 2).

### BACKGROUND ART DOCUMENT

### Patent Document

Patent Document 1: JP-A-2008-247732
Patent Document 2: WO 2010/126977

### SUMMARY OF THE INVENTION

### Problems that the Invention is to Solve

In a case where a strengthened glass sheet is cut using a laser beam, it is necessary to optimize the conditions of the laser beam to be irradiated on the strengthened glass sheet. That is, in a case where the conditions of the laser beam to be irradiated on a strengthened glass sheet were not appropriate, there was a problem in that a crack extended in an unintended direction, the cutting line ran off a designed cut line, and the quality of the cut strengthened glass sheet deteriorated.

In consideration of the above-described problem, an object of the invention is to provide a method for cutting a strengthened glass sheet and an apparatus for cutting a strengthened glass sheet in which a strengthened glass sheet is cut using a laser beam without causing a deterioration of quality.

### Means for Solving the Problems

A method for cutting a strengthened glass sheet according to an embodiment of the invention is a method for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet, wherein, in a case where the strengthened glass sheet is cut so as to have a predetermined curvature radius, an irradiation energy per unit irradiation area of the laser beam to be irradiated on the strengthened glass sheet is increased as the curvature radius decreases.

A method for cutting a strengthened glass sheet according to an embodiment of the invention is a method for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet, wherein an irradiation energy per unit irradiation area of the laser beam to be irradiated on the strengthened glass sheet is increased as the inside residual tensile stress increases.

A method for cutting a strengthened glass sheet according to an embodiment of the invention is a method for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet, wherein an output of the laser beam is increased as a moving rate of the irradiation region of the laser beam to be irradiated on the strengthened glass sheet increases.

An apparatus for cutting a strengthened glass sheet according to an embodiment of the invention is an apparatus for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet, the apparatus comprising: a glass holding and driving unit which holds the strengthened glass sheet and moves the strengthened glass sheet in a predetermined direction; a laser output unit which outputs a laser beam for cutting the strengthened glass sheet; a control unit which controls the glass holding and driving unit and the laser output unit based on a control program; and a control program-generating unit which generates the control program, wherein the control program-generating unit generates a control program which controls an area of the irradiation region of the laser beam, an output of the laser beam and a moving rate of the irradiation region of the laser beam in accordance with a curvature radius in a designed cut line for the strengthened glass sheet.

### Advantage of the Invention

The invention provides a method for cutting a strengthened glass sheet and an apparatus for cutting a strengthened glass sheet in which a strengthened glass sheet is cut using a laser beam without causing a deterioration of quality.

### BRIEF DESCRIPTION OF THE DRAWINGS

FIG. 1 is a cross-sectional view of a strengthened glass sheet.

FIG. 2 is a view illustrating the distribution of a compressive stress in the strengthened glass sheet of FIG. 1.

FIG. 3 is a view for describing a method for cutting a strengthened glass sheet.

FIG. 4 is a cross-sectional view cut along an A-A line in FIG. 3.

FIG. 5 is a cross-sectional view cut along a B-B line in FIG. 3.

FIG. 6 is a view for describing a method for cutting a strengthened glass sheet according to an embodiment of the invention.

FIG. 7 is a table describing the cutting results of strengthened glass sheets.

FIG. 8 is a table describing the cutting result of a non-strengthened glass sheet.

FIG. 9 is a view for describing an apparatus for cutting the strengthened glass sheet according to an embodiment of the invention.

FIG. 10 is a table for describing Example 1 of the invention.

FIG. 11 is a graph for describing Example 1 of the invention.

FIG. 12 is a table for describing Example 2 of the invention.

FIG. 13 is a table for describing Example 2 of the invention.

FIG. 14 is a graph for describing Example 2 of the invention.

FIG. 15 is a table for describing Example 3 of the invention.

### MODE FOR CARRYING OUT THE INVENTION

Hereinafter, an embodiment of the invention will be described with reference to the accompanying drawings. First, the structure of a strengthened glass sheet and the principle of a method for cutting a strengthened glass sheet will be described.

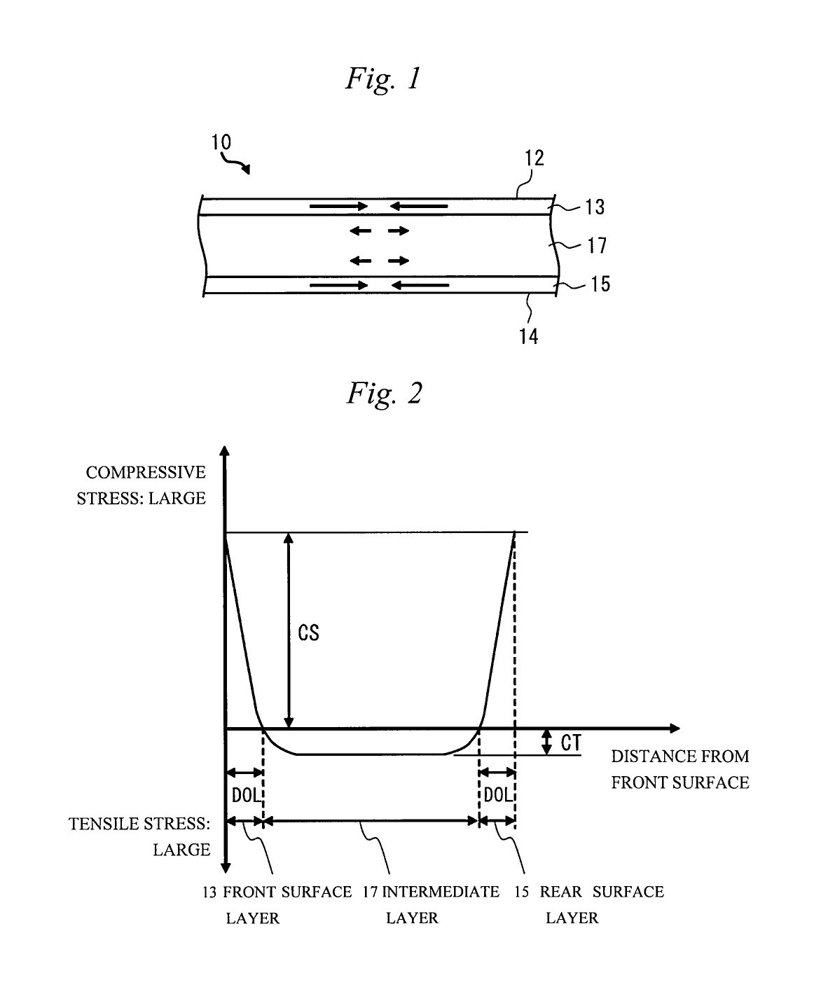

FIG. 1 is a cross-sectional view of a strengthened glass sheet, and FIG. 2 is a view illustrating the distribution of a residual stress in the strengthened glass sheet illustrated in FIG. 1. In FIG. 1, the direction of an arrow represents a stress-acting direction, and the length of an arrow represents the intensity of a stress.

As described in FIG. 1, a strengthened glass sheet 10 includes a front surface layer 13 and a rear surface layer 15 which have a residual compressive stress, and an intermediate layer 17 which is provided between the front surface layer 13 and the rear surface layer 15 and has an inside residual tensile stress. There is a tendency of the compressive stress (>0) remaining in the front surface layer 13 and the rear surface layer 15 to gradually decrease toward an inside from a front surface 12 and a rear surface 14 of the strengthened glass sheet 10 as illustrated in FIG. 2. In addition, there is a tendency of the tensile stress (>0) remaining in the intermediate layer 17 to gradually decrease toward the front surface 12 and the rear surface 14 from the inside of the glass.

In FIG. 2, CS represents the maximum residual compressive stress (surface compressive stress) (>0) in the front surface layer 13 or the rear surface layer 15, CT represents the inside residual tensile stress (the average value of the residual tensile stress in the intermediate layer 17) (>0) in the intermediate layer 17, and DOL represents the thickness of the front surface layer 13 or the rear surface layer 15, respectively. CS, CT and DOL can be adjusted by the conditions of a strengthening treatment. For example, in a case in which a thermal-tempering-by-air-jets method is used, CS, CT and DOL can be adjusted by the cooling rate and the like of glass. In addition, in a case in which a chemical strengthening method is used, since glass is immersed in a treatment liquid (for example, molten KNO₃ salt) so as to be ion-exchanged, CS, CT and DOL can be adjusted by the concentration, temperature of the treatment liquid, the immersion time, and the like. Meanwhile, the front surface layer 13 and the rear surface layer 15 have the same thickness and the same maximum residual compressive stress, but may have different thicknesses, and may have different maximum residual compressive stresses.

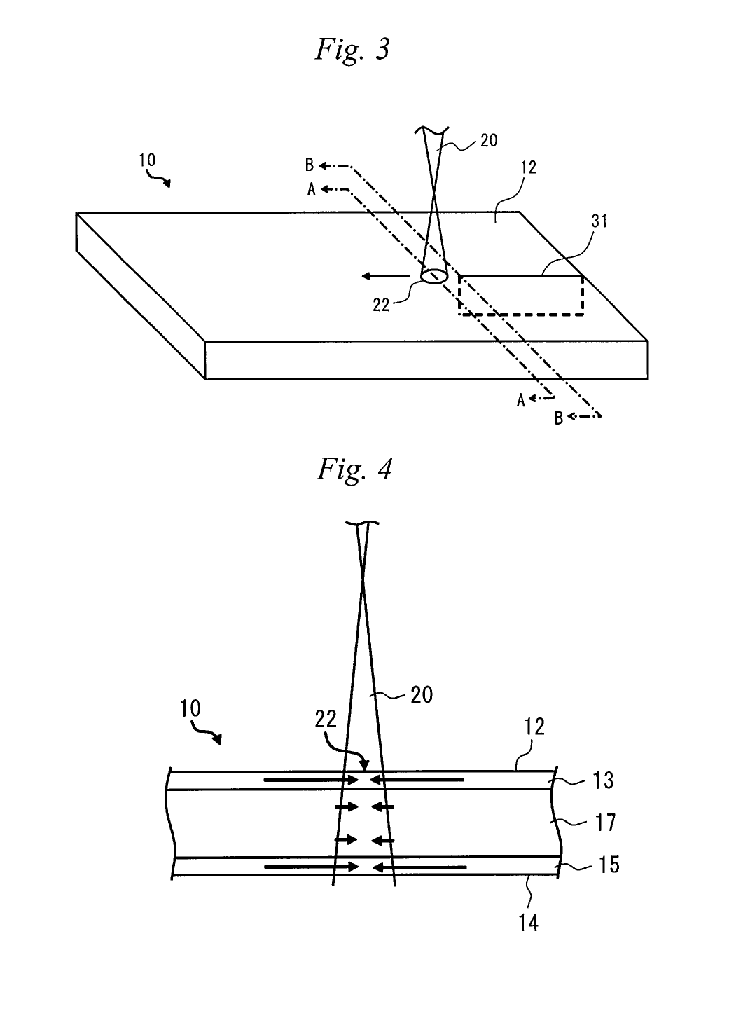

FIG. 3 is a view for describing a method for cutting a strengthened glass sheet. As illustrated in FIG. 3, a laser beam 20 is irradiated on the front surface 12 of the strengthened glass sheet 10, and an irradiation region 22 of the laser beam 20 is moved (scanned) on the front surface 12 of the strengthened glass sheet 10 so as to apply a stress to the strengthened glass sheet 10, thereby cutting the strengthened glass sheet 10.

An initial crack has been formed in advance at a cutting initiation location in an end portion of the strengthened glass sheet 10. The initial crack may be formed using an ordinary method, for example, using a cutter, a file or a laser beam. In order to decrease the number of processes, the initial crack may not have been formed in advance.

On the front surface 12 of the strengthened glass sheet 10, the irradiation region 22 of the laser beam 20 is moved in a straight line shape or a curved line shape along a designed cutting line from the end portion of the strengthened glass sheet 10 toward the inside. Thereby, a crack 31 is formed from the end portion of the strengthened glass sheet 10 toward the inside, and the strengthened glass sheet 10 is cut. The irradiation region 22 of the laser beam 20 may be moved in a P shape, and, in this case, a terminal of a moving path intersects the middle of the moving path.

A light source of the laser beam 20 is not particularly limited, and examples thereof include a UV laser (wavelength: 355 nm), a green laser (wavelength: 532 nm), a semiconductor laser (wavelength: 808 nm, 940 nm, and 975 nm), a fiber laser (wavelength: 1060 nm to 1100 nm), a YAG laser (wavelength: 1064 nm, 2080 nm, and 2940 nm), and a laser generated using a mid-infrared parametric oscillator (wavelength: 2600 nm to 3450 nm). A method for oscillating the laser beam 20 is not limited, and any one of a CW laser which continuously oscillates a laser beam and a pulse laser which intermittently oscillates a laser beam can be used. In addition, the intensity distribution of the laser beam 20 is not limited, and the intensity distribution may be a Gaussian type or a top-hat type.

In a case where the strengthened glass sheet 10 and the laser beam 20 satisfy a formula 0<α×t≦3.0, in which α (cm⁻¹) represents the absorption coefficient of the strengthened glass sheet 10 with respect to the laser beam 20 and t (cm) represents the thickness of the strengthened glass sheet 10, it is possible to cut the strengthened glass sheet 10 using not only the action of the laser beam 20 but also the extension of a crack caused by the inside residual tensile stress in the intermediate layer 17. That is, when the intermediate layer 17 in the irradiation region 22 of the laser beam 20 is heated at a temperature equal to or lower than an annealing point under the above-described conditions, it becomes possible to cut the strengthened glass sheet 10 using the crack 31 caused by the inside residual tensile stress by controlling the extension of the crack 31 caused in the strengthened glass sheet 10 using the inside residual tensile stress in the intermediate layer 17. Meanwhile, the reason for heating the intermediate layer 17 at a temperature equal to or lower than an annealing point is that, when the intermediate layer 17 is heated at a temperature higher than the annealing point, the temperature of glass becomes high although the laser beam passes the glass within a short period of time, and there is a high probability of the glass to viscously flow, and therefore the compressive stress generated by the laser beam is relaxed due to the viscous flow.

When the intensity of the laser beam 20 prior to be entered to the strengthened glass sheet 10 is represented by I₀, and the intensity of the laser beam 20 when moving distance L (cm) on the strengthened glass sheet 10 is represented by I, a formula I=I₀×e×p(−α×L) is satisfied. This formula is called the Lambert-Beer law.

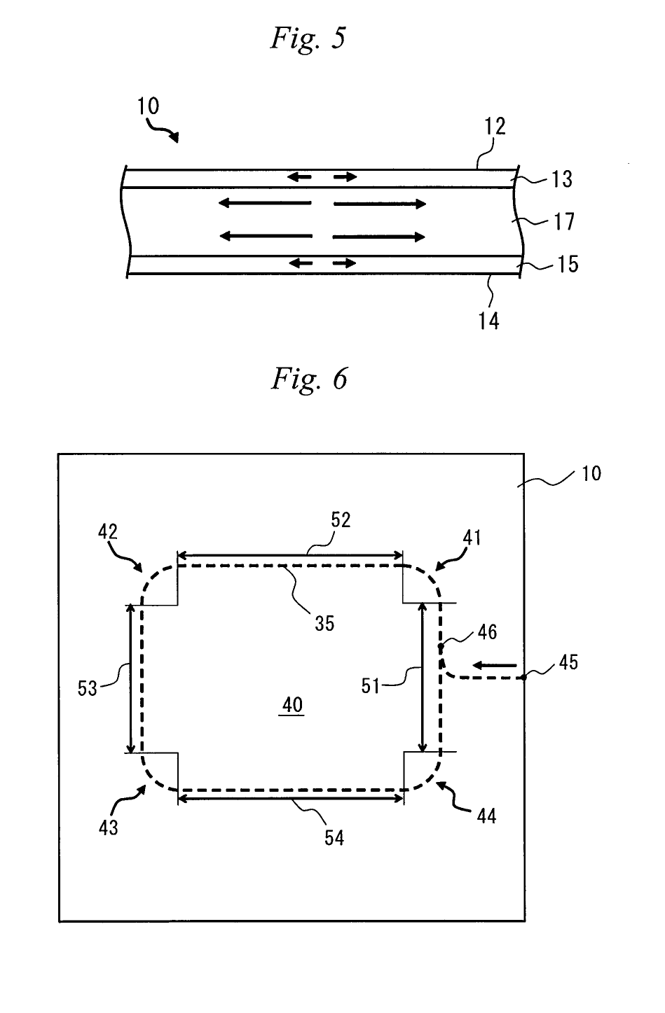

When α×t is set in a range of more than 0 and 3.0 or less, the laser beam 20 can reach the inside without being absorbed in the surface of the strengthened glass sheet 10, and therefore the inside of the strengthened glass sheet 10 can be sufficiently heated. As a result, a stress generated in the strengthened glass sheet 10 is changed into a state illustrated in FIG. 4 or 5 from a state illustrated in FIG. 1.

FIG. 4 is a cross-sectional view cut along an A-A line in FIG. 3, and is a cross-sectional view including the irradiation region of the laser beam. FIG. 5 is a cross-sectional view cut along a B-B line in FIG. 3, and is a cross-section behind the cross-section illustrated in FIG. 4. Here, the term “behind” refers to a rear part in a scanning direction of the laser beam 20. In FIGS. 4 and 5, the directions of arrows represent directions in which stresses act, and the lengths of the arrows represent the intensities of stresses.

In the intermediate layer 17 in the irradiation region 22 of the laser beam 20, since the intensity of the laser beam 20 is sufficiently high, the temperature becomes relatively high compared with that of the peripheries, and a tensile stress or a compressive stress which is smaller than the inside residual tensile stress illustrated in FIGS. 1 and 2 is generated. In a portion in which the tensile stress or the compressive stress which is smaller than the inside residual tensile stress is generated, the extension of the crack 31 is suppressed. In order to reliably prevent the extension of the crack 31, it is preferable to generate a compressive stress as illustrated in FIG. 4.

Meanwhile, in the front surface layer 13 or the rear surface layer 15 in the irradiation region 22 of the laser beam 20, since a compressive stress which is larger than the residual compressive stress illustrated in FIGS. 1 and 2 is generated as illustrated in FIG. 4, the extension of the crack 31 is suppressed.

Due to the equilibrium with the compressive stress illustrated in FIG. 4, in the cross-section behind the cross-section illustrated in FIG. 4, a tensile stress is generated in the intermediate layer 17 as illustrated in FIG. 5. The tensile stress is larger than the inside residual tensile stress, and the crack 31 is formed in a portion in which the tensile stress reaches a predetermined value. The crack 31 penetrates the strengthened glass sheet 10 from the front surface 12 to the rear surface 14, and the cutting illustrated in FIG. 3 is so-called full-cut cutting.

In this state, when the irradiation region 22 of the laser beam 20 is moved, a front end location of the crack 31 moves so as to follow the location of the irradiation region 22. That is, in the cutting method illustrated in FIG. 3, when the strengthened glass sheet 10 is cut, the extension direction of the crack 31 is controlled using a tensile stress (refer to FIG. 5) generated in the rear part in the scanning direction of the laser beam, and the strengthened glass sheet is cut while the extension of the crack 31 is suppressed using the compressive stress (refer to FIG. 4) generated in a region on which the laser beam is irradiated. Therefore, it is possible to suppress the crack 31 to run off the designed cut line to cause the deviant extension.

Depending on usage, glass needs to be highly transparent, and therefore α×t is preferably closer to 0 in a case where the wavelength of a laser beam to be used is closer to the wavelength range of visible light. However, when α×t is too small, the absorption efficiency deteriorates, and therefore α×t is preferably 0.0005 or more (laser beam absorption rate of 0.05% or more), more preferably 0.002 or more (laser beam absorption rate of 0.2% or more), and still more preferably 0.004 or more (laser beam absorption rate of 0.4% or more).

In contrast, depending on usage, glass needs to have a low transparency, and therefore α×t is preferably larger in a case where the wavelength of a laser beam to be used is closer to the wavelength range of visible light. However, when α×t is too large, the surface absorption of the laser beam becomes large, and therefore it becomes impossible to control the extension of the crack. Therefore, α×t is preferably 3.0 or less (laser beam absorption rate of 95% or less), more preferably 0.1 or less (laser beam absorption rate of 10% or less), and still more preferably 0.02 or less (laser beam absorption rate of 2% or less).

The absorption coefficient (α) is determined by the wavelength of the laser beam 20, the glass composition of the strengthened glass sheet 10, and the like. For example, as the content of iron oxides (including FeO, Fe₂O₃ and Fe₃O₄), the content of cobalt oxides (including CoO, Co₂O₃ and Co₃O₄) and the content of copper oxides (including CuO and Cu₂O) in the strengthened glass sheet 10 increases, the absorption coefficient (α) in a near infrared wavelength range near 1000 nm increases. Furthermore, as the content of oxides of rare earth elements (for example, Yb) in the strengthened glass sheet 10 increases, the absorption coefficient (α) near the absorption wavelength of rare earth atoms increases.

The absorption coefficient (α) in a near infrared wavelength range near 1000 nm is set depending on usage. For example, in the case of vehicle window glass, the absorption coefficient (α) is preferably set to 3 cm⁻¹ or less. In addition, in the case of building window glass, the absorption coefficient (α) is preferably set to 0.6 cm⁻¹ or less. In addition, in the case of display glass, the absorption coefficient (α) is preferably set to 0.2 cm⁻¹ or less.

The wavelength of the laser beam 20 is preferably in a range of 250 nm to 5000 nm. When the wavelength of the laser beam 20 is set in a range of 250 nm to 5000 nm, the transmittance of the laser beam 20 and the heating efficiency by the laser beam 20 can be both satisfied. The wavelength of the laser beam 20 is more preferably in a range of 300 nm to 4000 nm, and still more preferably in a range of 800 nm to 3000 nm.

The content of iron oxides in the strengthened glass sheet 10 is dependent on the type of glass that configures the strengthened glass sheet 10, and, in the case of soda lime glass, the content of iron oxides is, for example, in a range of 0.02% by mass to 1.0% by mass. When the content of iron oxides is adjusted in the above-described range, it is possible to adjust α×t in a near infrared wavelength range near 1000 nm in a desired range. Instead of the content of iron oxides, the content of cobalt oxides, copper oxides or oxides of rare earth elements may be adjusted.

The thickness (t) of the strengthened glass sheet 10 is set depending on usage, and is preferably in a range of 0.01 cm to 0.2 cm. In the case of chemical strengthened glass, when the thickness (t) is set to 0.2 cm or less, it is possible to sufficiently increase the inside residual tensile stress (CT). On the other hand, when the thickness (t) is less than 0.01 cm, it is difficult to carry out a chemical strengthening treatment on glass. The thickness (t) is more preferably in a range of 0.03 cm to 0.15 cm, and still more preferably in a range of 0.05 cm to 0.15 cm.

When the above-described method is used, it is possible to cut the strengthened glass sheet.

Next, a method for cutting a strengthened glass sheet according to the present embodiment will be described. FIG. 6 is a view for describing the method for cutting a strengthened glass sheet according to the present embodiment. FIG. 6 is a view of a top surface of the strengthened glass sheet 10. In addition, the broken line illustrated on the strengthened glass sheet 10 illustrates a designed cut line 35 along which a sample shape 40 is cut out from the strengthened glass sheet 10 using the above-described method for cutting a strengthened glass sheet. The sample shape 40 has a quadrilateral shape with four corner portions 41, 42, 43 and 44 having a predetermined curvature radius R and straight portions 51, 52, 53 and 54. Meanwhile, the sample shape 40 illustrated in FIG. 6 is an example, and, even in a case where a different arbitrary sample shape is cut out from the strengthened glass sheet 10, it is possible to use the method for cutting a strengthened glass sheet according to the present embodiment.

When the sample shape 40 is cut out from the strengthened glass sheet 10, a laser beam is scanned so as to pass the designed cut line 35. That is, the laser beam begins to be scanned from the cutting initiation location 45, is made to pass the straight portion 51, the corner portion 41, the straight portion 52, the corner portion 42, the straight portion 53, the corner portion 43, the straight portion 54 and the corner portion 44, and is scanned to a cutting termination location 46 on the straight portion 51. At this time, an initial crack has been formed in advance in the cutting initiation location 45, that is, the end portion of the strengthened glass sheet 10. The initial crack can be formed using, for example, a cutter, a file or a laser beam.

As described above, in a case where the strengthened glass sheet is cut using a laser beam, it is necessary to optimize the conditions of the laser beam to be irradiated on the strengthened glass sheet. That is, in a case where the conditions of the laser beam to be irradiated on the strengthened glass sheet were not appropriate, a crack extended in an unintended direction, the cutting line runs off the designed cut line, and there was a problem in that the quality of the cut strengthened glass sheet deteriorated.

Particularly, since the sample shape 40 illustrated in FIG. 6 has four corner portions 41, 42, 43 and 44 with a predetermined curvature radius R, it is necessary to optimize the conditions of the laser beam to be irradiated on the strengthened glass sheet depending on the curvature radius R of the corner portions 41, 42, 43 and 44.

As described above, in the present embodiment, when the strengthened glass sheet 10 is cut, the strengthened glass sheet is cut while the extension of the crack caused by the tensile stress (refer to FIG. 5) generated in the rear part in the scanning direction of the laser beam is suppressed using the compressive stress (refer to FIG. 4) generated in the region on which the laser beam is irradiated. At this time, the crack generated by the tensile stress generated in the rear part in the scanning direction tends to extend in a tangential direction of the scanning trajectory of the laser beam. Therefore, when the curvature radius R of the corner portion decreases (that is, the corner portion abruptly curves), it becomes impossible to control the extension direction of the crack caused by the tensile stress generated in the rear part in the scanning direction. Therefore, there was a case where the crack extended in an unintended direction and the cutting line ran off the designed cut line.

In the method for cutting a strengthened glass sheet according to the present embodiment, the irradiation energy per unit irradiation area of the laser beam to be irradiated on the strengthened glass sheet 10 increases as the curvature radius R decreases. Therefore, since it is possible to increase the tensile stress generated in the rear part in the scanning direction of the laser beam, even in a case where the curvature radius R is small, it is possible to cut the strengthened glass sheet 10 while controlling the extension direction of the crack in the rear part in the scanning direction of the laser beam.

Here, the irradiation energy E (J/mm²) per unit irradiation area of the laser beam can be expressed as the following formula (1) in which the output of the laser beam is represented by P (W), the scanning rate of the laser beam is represented by v (mm/s), and the beam diameter of the laser beam to be irradiated on the strengthened glass sheet 10 is represented by φ (mm).

E(J/mm²)=P(W)/(v(mm/s)×φ(mm)) (1)

That is, the irradiation energy E (J/mm²) per unit irradiation area of the laser beam refers to an energy irradiated on the area of the strengthened glass sheet 10 scanned by the laser beam for unit time (1 second). Hereinafter, the irradiation energy per unit irradiation area of the laser beam will be also expressed as the unit energy.

Meanwhile, since the straight line has a curvature radius of cc, it is possible to make the unit energy of the laser beam when cutting the straight portions 51, 52, 53 and 54 smaller than the unit energy of the laser beam when cutting the corner portions 41, 42, 43 and 44.

In addition, in the present embodiment, the strengthened glass sheet 10 is cut using the inside residual tensile stress in the intermediate layer 17 in the strengthened glass sheet 10. Therefore, it is necessary to optimize the conditions of the laser beam to be irradiated on the strengthened glass sheet depending on the inside residual tensile stress in the intermediate layer 17 in the strengthened glass sheet 10.

As described above, in the present embodiment, when the strengthened glass sheet 10 is cut, the extension direction of the crack 31 is controlled using the tensile stress (refer to FIG. 5) generated in the rear part in the scanning direction of the laser beam, and the strengthened glass sheet is cut while the extension of the crack 31 is suppressed using the compressive stress (refer to FIG. 4) generated in a region on which the laser beam is irradiated. However, when the inside residual tensile stress in the intermediate layer 17 in the strengthened glass sheet 10 is large, the tensile stress induced from the inside residual tensile stress increases during the cutting, and therefore the crack becomes likely to extend. Since the crack is significantly influenced by the tensile stress induced from the inside residual tensile stress and is slightly influenced by the tensile stress generated in the rear part in the scanning direction of the laser beam, it becomes difficult to control the extension direction of the crack, the crack extends in an unintended direction, and there was a case where the cutting line ran off the designed cut line.

In the method for cutting a strengthened glass sheet according to the present embodiment, the irradiation energy per unit irradiation area of the laser beam to be irradiated on the strengthened glass sheet 10 is increased as the inside residual tensile stress in the intermediate layer 17 in the strengthened glass sheet 10 increases. Thereby, it is possible to make the tensile stress generated in the rear part in the scanning direction of the laser beam larger than the tensile stress induced from the inside residual tensile stress. Therefore, it is possible to suppress the extension of the crack in an unintended direction, which is caused by the inside residual tensile stress, and to make the crack preferentially extend along the scanning direction of the laser beam using the tensile stress generated in the rear part in the scanning direction of the laser beam, and therefore it is possible to cut the strengthened glass sheet 10 while controlling the extension direction of the crack.

For example, when the moving rate (scanning rate) of the irradiation region of the laser beam is decreased using the above-described formula (1), it is possible to increase the irradiation energy E (J/mm²) per unit irradiation area of the laser beam. In addition, when the output of the laser beam is increased, it is possible to increase the irradiation energy E (J/mm²) per unit irradiation area of the laser beam. In addition, when the area (that is, the beam radius φ) of the irradiation region of the laser beam is decreased, it is possible to increase the irradiation energy E (J/mm²) per unit irradiation area of the laser beam.

In addition, in the present embodiment, the irradiation energy E (J/mm²) per unit irradiation area of the laser beam may be decreased as the absorption coefficient α of the strengthened glass sheet 10 increases. In a case where the adsorption coefficient α is large, the energy absorbed in the strengthened glass sheet 10 increases, and therefore it is possible to decrease the irradiation energy E (J/mm²) per unit irradiation area of the laser beam by the same amount.

In addition, the irradiation energy E (J/mm²) per unit irradiation area of the laser beam may be increased as the thickness t of the strengthened glass sheet increases. In a case where the thickness t of the strengthened glass sheet is large, it is necessary to increase an energy being supplied to the strengthened glass sheet 10, and therefore the irradiation energy E (J/mm²) per unit irradiation area of the laser beam is preferably increased. In addition, the irradiation energy E (J/mm²) per unit irradiation area of the laser beam may be decreased as the thermal expansion coefficient of the strengthened glass sheet 10 increases. When the thermal expansion coefficient of the strengthened glass sheet 10 is large, the tensile stress generated in the rear part in the scanning direction of the laser beam increases, and therefore it is possible to decrease the irradiation energy E (J/mm²) per unit irradiation area of the laser beam by the same amount.

In addition, in the present embodiment, it is necessary to optimize the output (power) of the laser beam depending on the scanning rate of the laser beam that cuts the strengthened glass sheet 10. That is, when the scanning rate of the laser beam increases, the irradiation energy E per unit irradiation area of the laser beam decreases based on the above-described formula (1). Therefore, when the output of the laser beam is increased by increasing the scanning rate of the laser beam, it is possible to suppress the decrease in the irradiation energy E per unit irradiation area of the laser beam. At this time, it is possible to cut the strengthened glass sheet along the designed cut line by setting the output of the laser beam so that the value of the irradiation energy E per unit irradiation area of the laser beam becomes equal to or larger than a value necessary to cut the strengthened glass sheet 10.

According to the method for cutting a strengthened glass sheet of the present embodiment which has been described above, it is possible to cut a strengthened glass sheet using a laser beam without causing a deterioration of quality.

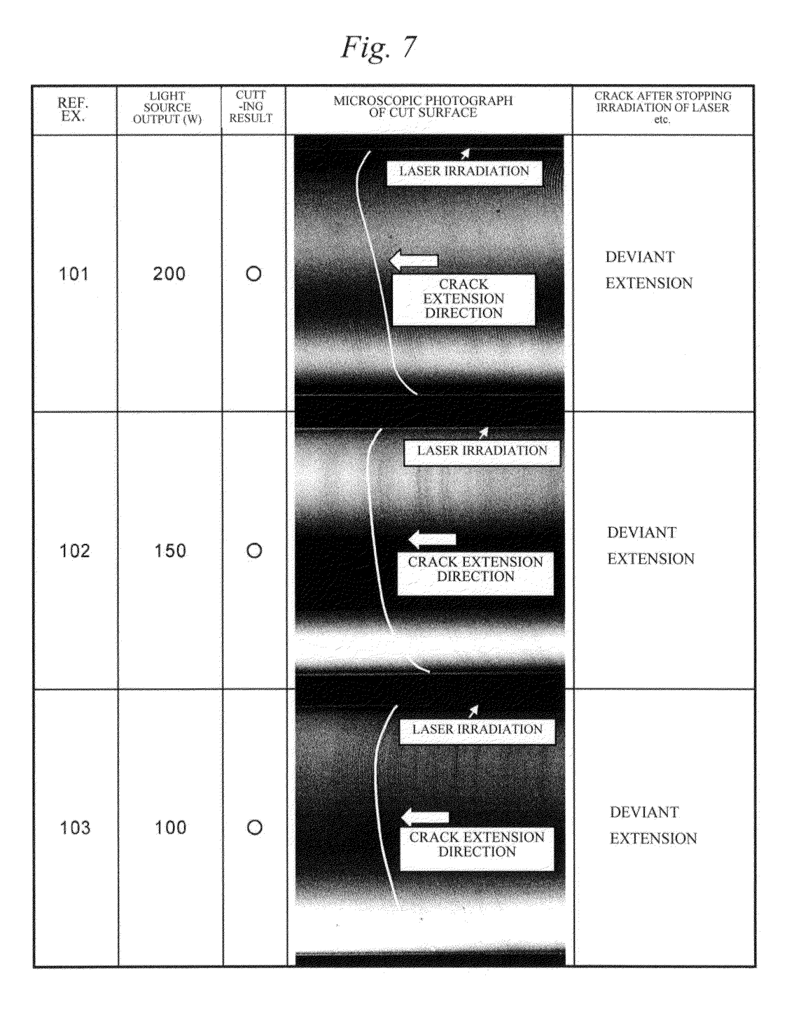

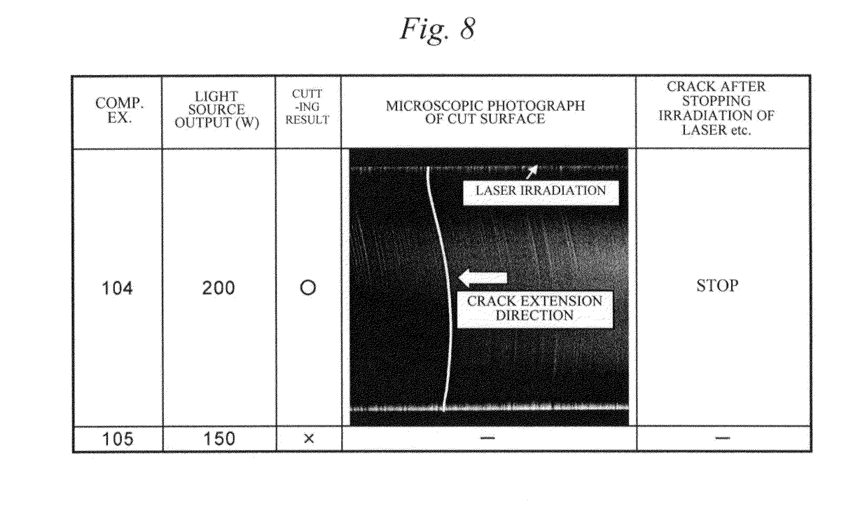

Next, the fact that the pattern of the extension of the crack is different in a method for cutting a strengthened glass sheet and in a method for cutting a non-strengthened glass sheet will be described with reference to FIGS. 7 and 8. FIG. 7 is a table describing the cutting results of strengthened glass sheets, and FIG. 8 is a table describing the cutting result of a non-strengthened glass sheet.

In Reference Examples 101 to 103, strengthened glass sheets were prepared, and, in Comparative Examples 104 and 105, non-strengthened glass sheets were prepared. The strengthened glass sheets of Reference Examples 101 to 103 had the same dimensions and the same shape as the non-strengthened glass sheets of Comparative Examples 104 and 105 (rectangular shape, long side being 100 mm, short side being 60 mm, and sheet thickness of 0.7 mm), and were produced by strengthening glass sheets having the same chemical composition using a chemical strengthening method. The strengthened glass sheets had an inside residual tensile stress (CT) of 30.4 MPa, a maximum residual compressive stress (CS) of 763 MPa, and a thickness (DOL) of a compressive stress layer (front surface layer or rear surface layer) of 25.8 μm.

In Reference Examples 101 to 103 and Comparative Examples 104 and 105, cutting tests were carried out under the same conditions except for the type of the glass sheet (strengthened or non-strengthened) and the output of the light source.

<Common Conditions>

Light source of the laser beam: fiber laser (wavelength of 1070 nm)

Incident angle of the laser beam on the glass sheet: 0°

Converging angle of the laser beam: 2.5°

Converging location of the laser beam: a location 23 mm away from the surface of the glass sheet toward the light source

Diameter of the laser beam spot on the surface of the glass sheet: φ1 mm

Absorption coefficient (α) of the glass sheet with respect to the laser beam: 0.09 cm⁻¹

Thickness of the glass sheet (t): 0.07 cm

Young's modulus (E) of the glass sheet: 74000 MPa

α×t: 0.0063

Diameter of the nozzle outlet: φ1 mm

Flow rate of the cooling gas (compressed air at room temperature) from the nozzle: 30 L/min

Intended cutting location: a straight line in parallel with the short side of the glass sheet (10 mm away from one short side and 90 mm away from the other short side)

Cutting rate: 2.5 mm/s

After cutting, the cut surface of the glass sheet was observed using a microscope. The stripe shape observed on the cut surface of the glass sheet indicates the change over time of the front end location of a continuously extending crack. The pattern of the extension of the crack can be found from each of the stripe shapes. In the microscopic photographs illustrated in FIGS. 7 and 8, representative lines of the stripe shapes are stressed using thick white lines.

In addition, the shapes of the cracks caused when the laser beam irradiation and the gas cooling were stopped in the middle of the cutting of the glass sheet were visually observed.

The test results of Reference Examples 101 to 103 and Comparative Examples 104 and 105 are described in FIGS. 7 and 8. In FIGS. 7 and 8, a case where a crack was formed in the glass sheet (a case where the glass sheet could be cut) was indicated as “O”, and a case where a crack was not formed in the glass sheet (a case where the glass sheet could not be cut) was indicated as “X”. The lines of the stripe shapes on the microscopic photographs of the cut surfaces of FIGS. 7 and 8 indicate the locations of the front ends of the cracks at a certain point of time. The “deviant extension” in FIGS. 7 and 8 means that the crack extends toward a short side of the two short sides of the glass sheet which is closer to the cutting location after stopping the irradiation of the laser beam and the like.

In the cutting of the non-strengthened glass sheet according to Comparative Examples 104 and 105, as is evident from the microscopic photographs of the cut surfaces, there was a tendency that both end portions of the glass sheet in the sheet thickness direction were broken prior to the central portion of the glass sheet in the sheet thickness direction. In addition, when the laser beam irradiation and the gas cooling were stopped in the middle of the cutting, the extension of the crack stopped. In addition, in the cutting of the non-strengthened glass sheet, a large output of the light source was required.

In contrast, in the cutting of the strengthened glass sheet according to Reference Examples 101 to 103, as is evident from the microscopic photographs of the cut surfaces, there was a tendency that the central portion of the glass sheet in the sheet thickness direction was broken prior to both end portions of the glass sheet in the sheet thickness direction. This is because the inside tensile stress is originally present in the strengthened glass sheet and the crack extends due to the inside residual tensile stress. In addition, when the laser beam irradiation and the gas cooling were stopped in the middle of the cutting, the crack extended in an unintended direction on its own. From the above-described result, it is found that the extension of the crack due to the residual tensile stress can be suppressed using the irradiation of a laser beam.

As described above, in the method for cutting a strengthened glass sheet and the method for cutting a non-strengthened glass sheet, the cutting mechanisms are fundamentally different, and the patterns of the extension of the crack are totally different. Therefore, in the invention, it is possible to obtain effects that cannot be expected from the method for cutting non-strengthened glass. The reason thereof will be described below.

For example, in the method for cutting a non-strengthened glass sheet, a thermal stress field is formed in the glass sheet using both a laser beam and a cooling liquid so as to generate a tensile stress necessary for cutting. More specifically, a laser beam is irradiated on the glass sheet so as to generate a thermal stress in the glass sheet, a compressive stress generated by the thermal stress is quenched using a cooling liquid so as to generate a tensile stress, thereby extending the crack. Therefore, the crack is extended using only the irradiation energy of the laser beam, and it is necessary to set the power (W) of the laser beam to be irradiated on the glass sheet to be large.

In the above-described method, the front end location of a cutting fissure formed in the glass sheet is determined by the location of the cooling liquid that cools the glass sheet. This is because a tensile stress is generated in the location of the cooling liquid. Therefore, when heating using a laser beam and cooling using the cooling liquid are stopped in the middle of the cutting, the extension of the crack stops.

In contrast, in the method for cutting a strengthened glass sheet, since a residual tensile stress is originally present in the glass sheet, unlike the case of the cutting of a non-strengthened glass sheet, it is not necessary to generate a tensile stress using a laser beam. In addition, therefore, when a certain force is exerted on the strengthened glass sheet so as to generate a crack, the crack extends on its own due to the inside residual tensile stress. On the other hand, since the inside residual tensile stress is present throughout the inside of the glass sheet, the crack extends in an unintended direction as long as the extension of the crack is not controlled.

Therefore, in the invention, a tensile stress or a compressive stress, which is smaller than the value of the inside residual tensile stress, is formed in the intermediate layer at the center of the irradiation region, thereby controlling the extension of the crack caused by the inside residual tensile stress. That is, the extension of the crack is controlled by decreasing the residual tensile stress in the intermediate layer in the strengthened glass sheet using the irradiation of the laser beam.

As described above, in the method for cutting a strengthened glass sheet and the method for cutting a non-strengthened glass sheet, the patterns of the extension of the crack are different.

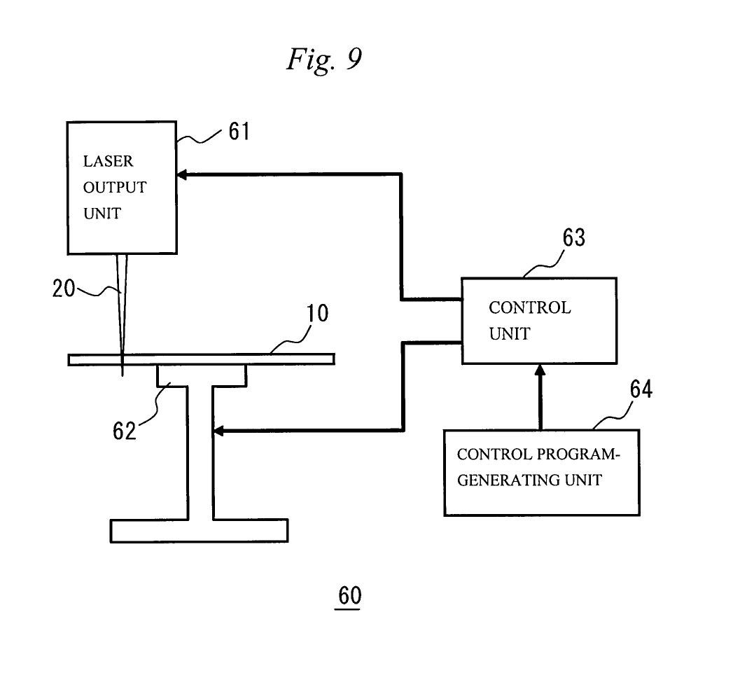

Next, an apparatus for cutting a strengthened glass sheet, for carrying out the method for cutting a strengthened glass sheet according to the present embodiment, which has been described above, will be described. FIG. 9 is a view for describing an apparatus for cutting the strengthened glass sheet according to the present embodiment. An apparatus for cutting a strengthened glass sheet 60 according to the present embodiment includes a laser output unit 61, a glass holding and driving unit 62, a control unit 63 and a control program-generating unit 64.

The laser output unit 61 outputs the laser beam 20 for cutting the strengthened glass sheet 10. Examples of a light source of the laser beam 20 include a UV laser (wavelength: 355 nm), a green laser (wavelength: 532 nm), a semiconductor laser (wavelength: 808 nm, 940 nm, and 975 nm), a fiber laser (wavelength: 1060 nm to 1100 nm), a YAG laser (wavelength: 1064 nm, 2080 nm, and 2940 nm), and a laser generated using a mid-infrared parametric oscillator (wavelength: 2600 nm to 3450 nm). The laser output unit 61 includes an optical system for adjusting the focal point of the laser beam. In addition, a nozzle may be disposed in an irradiation portion of the laser beam. The power of the laser beam (laser output), the beam diameter (focal point) of the laser beam, the timing of laser irradiation, and the like are controlled using the control unit 63.

Here, in a case where a near infrared laser beam is used, it is necessary to add impurities such as Fe to the strengthened glass sheet to increase the absorption in a near infrared range. In a case where impurities having an absorption characteristic in a near infrared range are added, since the absorption characteristic in a visible light range is also influenced, there is a case where the color or transmittance of the strengthened glass sheet is influenced. In order to prevent the above-described influence, a mid-infrared laser having a wavelength in a range of 2500 nm to 5000 nm may be used as the light source of the laser beam 20. At a wavelength in a range of 2500 nm to 5000 nm, since the absorption due to the molecular vibration of the glass itself generates, it is not necessary to add impurities such as Fe.

The glass holding and driving unit 62 holds the strengthened glass sheet 10 which is a workpiece and moves the strengthened glass sheet 10 in a predetermined direction. That is, the glass holding and driving unit 62 moves the strengthened glass sheet 10 so that the laser beam scans the strengthened glass sheet 10 along the designed cut line. The glass holding and driving unit 62 is controlled using the control unit 63. The glass holding and driving unit 62 may fix the strengthened glass sheet 10 which is a workpiece, using a porous sheet or the like. In addition, the glass holding and driving unit 62 may include an image detector for determining the location of the strengthened glass sheet 10. When an image detector for location determination is included, it is possible to improve the process accuracy of the strengthened glass sheet 10.

Meanwhile, in the apparatus for cutting a strengthened glass sheet 60 illustrated in FIG. 9, the strengthened glass sheet 10 is moved using the glass holding and driving unit 62 so that the irradiation region of the laser beam 20 moves on the strengthened glass sheet 10. At this time, the laser output unit 61 is fixed. However, the irradiation region of the laser beam 20 may be moved on the strengthened glass sheet 10 by fixing the strengthened glass sheet 10 being held in the glass holding and driving unit 62 and moving the laser output unit 61. In addition, both the strengthened glass sheet 10 being held in the glass holding and driving unit 62 and the laser output unit 61 may be configured to be movable.

The control unit 63 controls the laser output unit 61 and the glass holding and driving unit 62 based on a control program generated in the control program-generating unit 64.

The control program-generating unit 64 generates a control program which controls the irradiation energy per unit irradiation area of the laser beam to be irradiated on the strengthened glass sheet based on at least one of the thermal expansion coefficient and thickness of the strengthened glass sheet 10, the absorption coefficient of the strengthened glass sheet with respect to the laser beam, and the inside residual tensile stress in the intermediate layer 17 in the strengthened glass sheet. In addition, the control program-generating unit 64 generates a control program which controls the area (that is, the beam diameter φ) of the irradiation region of the laser beam, the output of the laser beam, and the scanning rate of the laser beam based on the curvature radius in the designed cut line for the strengthened glass sheet 10.

That is, the control program-generating unit 64 determines the irradiation energy per unit irradiation area of the laser beam to be irradiated on the strengthened glass sheet when cutting the straight portions based on the previously-set properties (thermal expansion coefficient, thickness, the absorption coefficient of the strengthened glass sheet with respect to the laser beam, the inside residual tensile stress in the intermediate layer 17 in the strengthened glass sheet, and the like) of the strengthened glass sheet 10. In addition, the control program-generating unit generates a control program which controls the beam diameter of the laser beam, the output of the laser beam, and the scanning rate of the laser beam based on the determined unit energy.

In addition, the control program-generating unit 64 generates a control program for controlling the laser output unit 61 and the glass holding and driving unit 62 based on the curvature radius of the strengthened glass sheet 10 in the designed cut line. That is, the control program-generating unit generates a control program for controlling the laser output unit 61 and the glass holding and driving unit 62 so that the unit energy of the laser beam increases as the curvature radius R of the strengthened glass sheet 10 in the designed cut line decreases using the unit energy when cutting the straight portions (curvature radius R=∞) as a standard. Specifically, the control program-generating unit 64 generates a control program which controls the laser output unit 61 and the glass holding and driving unit 62 so that the beam diameter of the laser beam decreases, the output of the laser beam increases, or the scanning rate of the laser beam decreases in order to increase the irradiation energy of the laser beam.

As described above, the invention according to the present embodiment enables the provision of a method for cutting a strengthened glass sheet and an apparatus for cutting a strengthened glass sheet with which a strengthened glass sheet is cut using a laser beam without causing a deterioration of quality.

### EXAMPLES

Hereinafter, examples of the invention will be described. In Example 1, the relationship between the curvature radius R of the strengthened glass sheet and the irradiation energy E (J/mm²) per unit irradiation area of the laser beam will be specifically described. In addition, in Example 2, the relationship between the inside residual tensile stress in the intermediate layer of the strengthened glass sheet and the irradiation energy E (J/mm²) per unit irradiation area of the laser beam will be specifically described. In addition, in Example 3, the relationship between the scanning rate of the laser beam when cutting the strengthened glass sheet and the irradiation energy E (J/mm²) per unit irradiation area of the laser beam will be specifically described.

### Example 1

In Example 1, a strengthened glass sheet having a sheet thickness of 0.7 (mm), a surface compressive stress CS of 761.6 (MPa), a thickness DOL of each of the front surface layer and the rear surface layer of 39.7 (μm) and an inside residual tensile stress CT of 48.7 (MPa) was used.

The inside residual tensile stress CT of the strengthened glass sheet was obtained as follows. The surface compressive stress CS and the thicknesses DOL of the compressive stress layers (the front surface layer and the rear surface layer) were measured using a surface stress meter FSM-6000 (manufactured by Orihara Industrial Co., Ltd.) and the inside residual tensile stress was calculated from the measured values and the thickness t of the strengthened glass sheet using the following formula (2).

CT=(CS×DOL)/(t−2×DOL) (2)

The strengthened glass sheet was cut using the cutting method described in the present embodiment. An initial crack was formed in advance in the cutting initiation location at an end portion of the strengthened glass sheet, but scribe lines were not formed on the surface of the strengthened glass sheet. A fiber laser (central wavelength band of 1070 nm) was used as the light source of the laser beam.

In Example 1, the strengthened glass sheet was cut straightly from the cutting initiation location by a predetermined distance, and then was cut so as to produce a corner portion having a predetermined curvature radius R. The straight portion and the corner portion were continuously cut.

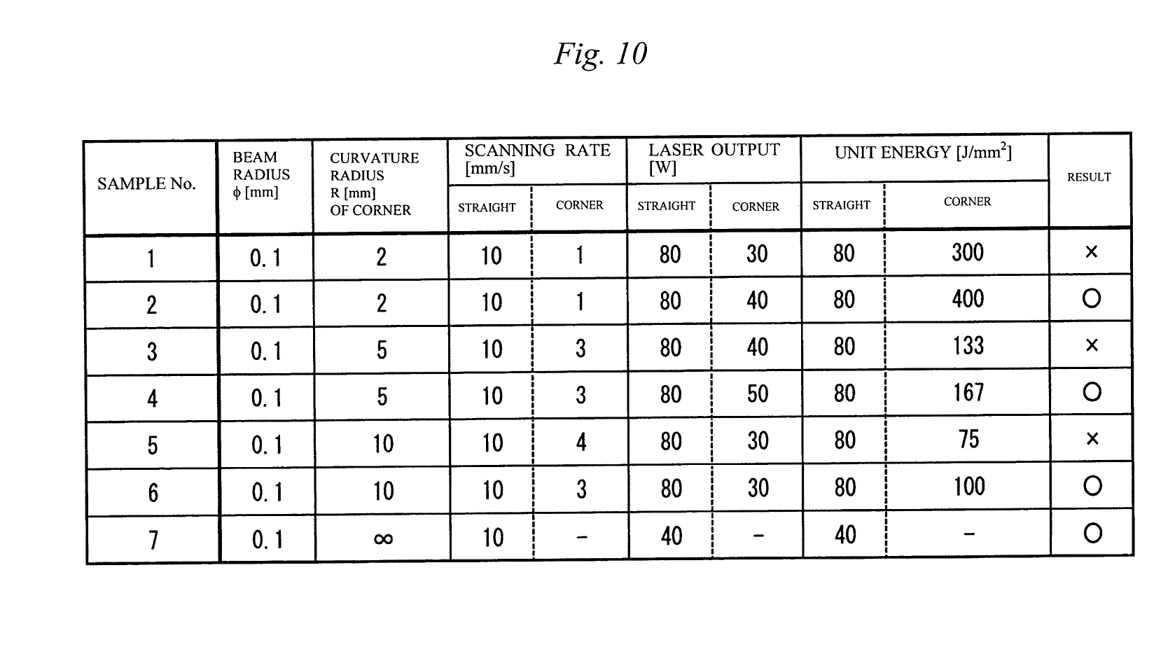

FIG. 10 describes the cutting conditions of the strengthened glass sheet and the cutting results. The table described in FIG. 10 shows the beam diameter φ (mm), the curvature radius R (mm) of the corner portion, the scanning rate (mm/s) of the laser beam at the straight portion and the corner portion, the laser output (W) at the straight portion and the corner portion, and the irradiation energy E (J/mm²) per unit irradiation area of the laser beam at the straight portion and the corner portion as the conditions for cutting each of Sample Nos. 1 to 7. In Example 1, the beam diameters φ were all fixed to 0.1 (mm). In addition, the irradiation energy (unit energy) E (J/mm²) per unit irradiation area of the laser beam was obtained by substituting the laser output (W), the scanning rate (mm/s) of the laser beam, and the beam diameter φ (mm) into the above-described formula (1).

For example, in a case where Sample No. 1 was cut, the scanning rate and the laser output at the straight portion were set to 10 (mm/s) and 80 (W) respectively, and the scanning rate and the laser output at the corner portion were set to 1 (mm/s) and 30 (W) respectively. At this time, the unit energy E of the laser beam at the straight portion was 80 (J/mm²), and the unit energy E of the laser beam at the corner portion was 300 (J/mm²).

The cutting result was indicated as “O” in a case where the strengthened glass sheet could be cut along the designed cut line, and was indicated as “X” in a case where the extension of the crack could not be controlled and the crack ran off the designed cut line to cause the deviant extension and in a case where the strengthened glass sheet could not be cut and the glass was crushed.

In both Sample No. 1 and Sample No. 2, the curvature radius R at the corner portion was set to 2 (mm), the scanning rate at the straight portion was set to 10 (mm/s), the laser output at the straight portion was set to 80 (W), and the scanning rate at the corner portion was set to 1 (mm/s). In addition, the laser output at the corner portion of Sample No. 1 was set to 30 (W), and the laser output at the corner portion of Sample No. 2 was set to 40 (W). When the cutting results of Sample No. 1 and Sample No. 2 are compared, in Sample No. 1, the strengthened glass sheet was cut in a swelling manner at the corner portion. That is, in Sample No. 1, the extension of the crack could not be appropriately controlled, and therefore the crack ran off the designed cut line. In contrast, in Sample No. 2, it was possible to cut the strengthened glass sheet along the designed cut line.

In both Sample No. 3 and Sample No. 4, the curvature radius R at the corner portion was set to 5 (mm), the scanning rate at the straight portion was set to 10 (mm/s), the laser output at the straight portion was set to 80 (W), and the scanning rate at the corner portion was set to 3 (mm/s). In addition, the laser output at the corner portion of Sample No. 3 was set to 40 (W), and the laser output at the corner portion of Sample No. 4 was set to 50 (W). When the cutting results of Sample No. 3 and Sample No. 4 are compared, in Sample No. 3, the crack ran off the designed cut line at the corner portion to cause the deviant extension. That is, in Sample No. 3, the extension of the crack could not be appropriately controlled, and therefore the crack ran off the designed cut line. In contrast, in Sample No. 4, it was possible to cut the strengthened glass sheet along the designed cut line.

In both Sample No. 5 and Sample No. 6, the curvature radius R at the corner portion was set to 10 (mm), the scanning rate at the straight portion was set to 10 (mm/s), the laser output at the straight portion was set to 80 (W), and the laser output at the corner portion was set to 30 (W). In addition, the scanning rate of the laser beam at the corner portion of Sample No. 5 was set to 4 (mm/s), and the scanning rate of the laser beam at the corner portion of Sample No. 6 was set to 3 (mm/s). When the cutting results of Sample No. 5 and Sample No. 6 are compared, in Sample No. 5, the crack ran off the designed cut line at the corner portion to cause the deviant extension. That is, in Sample No. 5, the extension of the crack could not be appropriately controlled, and therefore the crack ran off the designed cut line. In contrast, in Sample No. 6, it was possible to cut the strengthened glass sheet along the designed cut line.

In addition, Sample No. 7 shows a case where the curvature radius R was ∞, that is, a case where the strengthened glass sheet was cut straightly. In Sample No. 7, the scanning rate of the laser beam at the straight portion was set to 10 (mm/s) and the laser output was set to 40 (W). In Sample No. 7, it was possible to cut the strengthened glass sheet along the designed cut line.

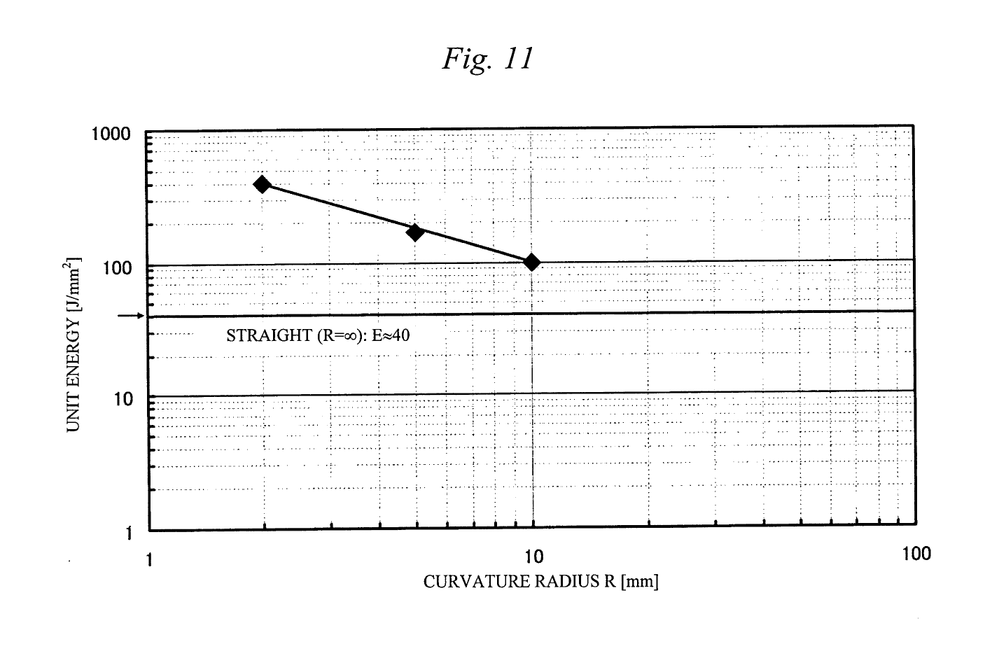

FIG. 11 is a graph illustrating the relationship between the curvature radius R (mm) at the corner portion and the irradiation energy (unit energy) E per unit irradiation area of the laser beam when cutting the corner portion having the curvature radius R. In the graph illustrated in FIG. 11, the results of Sample Nos. 2, 4 and 6 were plotted. As illustrated in the graph of FIG. 11, the unit energy E of the laser beam necessary to cut the corner portion increases as the curvature radius R decreases. In other words, the unit energy E of the laser beam necessary to cut the corner portion decreases as the curvature radius R increases. Meanwhile, the results of Sample No. 7 shows that an irradiation energy of 40 (J/mm²) is required to cut the straight portion (curvature radius R=∞).

From the above-described results, it is found that, when the strengthened glass sheet is cut, the unit energy of the laser beam to be irradiated on the strengthened glass sheet needs to increase as the curvature radius decreases.

### Example 2

Next, Example 2 of the invention will be described. In Example 2, the relationship between the inside residual tensile stress CT in the intermediate layer in the strengthened glass sheet and the irradiation energy E (J/mm²) per unit irradiation area of the laser beam will be specifically described.

In Example 2, a strengthened glass sheet having a sheet thickness of 1.1 (mm) was used. The value of the inside residual tensile stress CT was changed in accordance with the samples. The inside residual tensile stress CT was adjusted using the concentration and temperature of the treatment liquid for treating the glass, the immersion time of the glass in the treatment liquid, and the like in the chemical strengthening method. The strengthened glass sheet was cut using the cutting method described in the embodiment. An initial crack was formed in advance in the cutting initiation location at an end portion of the strengthened glass sheet, but scribe lines were not formed on the surface of the strengthened glass sheet. A fiber laser (central wavelength band of 1070 nm) was used as the light source of the laser beam. In Example 2, the strengthened glass sheet was cut straightly from the cutting initiation location by a predetermined distance. The scanning rate of the laser beam at this time was set to 20 (mm/s).

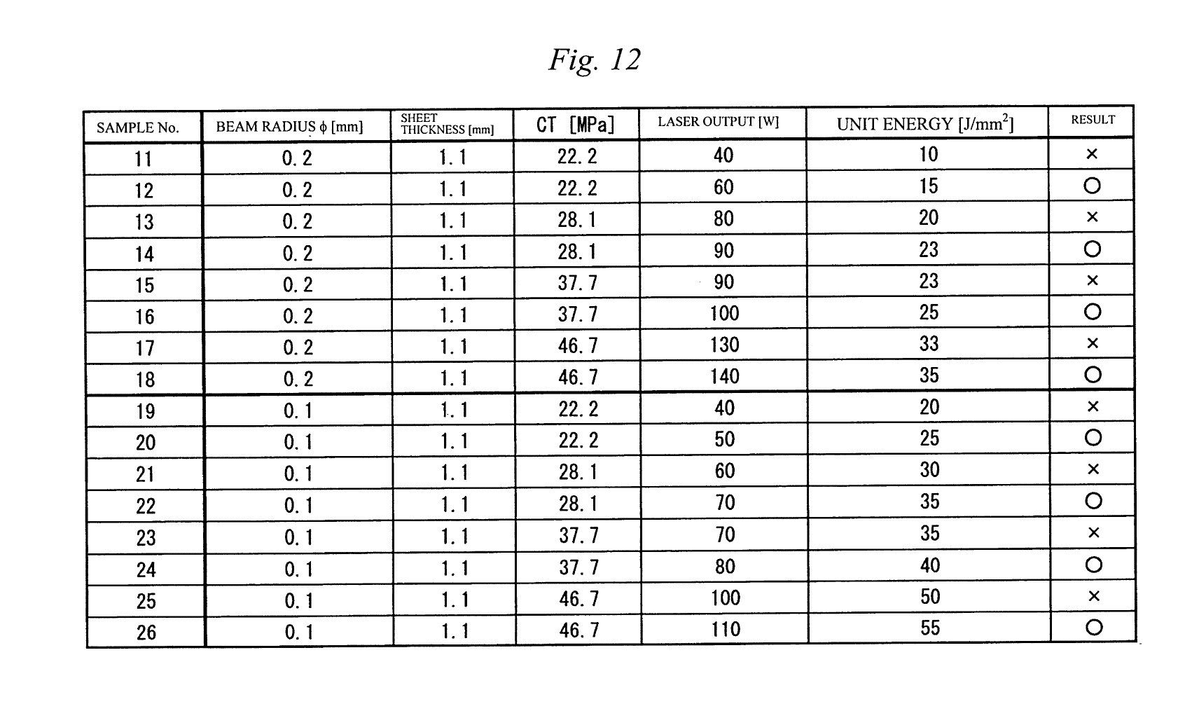

FIG. 12 describes the cutting conditions of the strengthened glass sheet and the cutting results. As illustrated in FIG. 12, the beam diameters φ when cutting Sample Nos. 11 to 18 was set to 0.2 (mm), and the beam diameters φ when cutting Sample Nos. 19 to 26 was set to 0.1 (mm). The cutting result was indicated as “O” in a case where the strengthened glass sheet could be cut along the designed cut line, and was indicated as “X” in a case where the extension of the crack could not be controlled and the crack ran off the designed cut line to cause the deviant extension and in a case where the strengthened glass sheet could not be cut and the glass was crushed. In addition, as illustrated in FIG. 12, tests in which samples having the same inside residual tensile stress CT were cut at two different laser outputs were carried out.

That is, Sample Nos. 11 and 12 had the same inside residual tensile stress CT of 22.2 (MPa), Sample No. 11 was cut at a laser output of 40 (W), and Sample No. 12 was cut at a laser output of 60 (W). At this time, Sample No. 12 could be cut along the designed cut line, but Sample No. 11 could not be cut along the designed cut line. Similarly, Sample Nos. 13 and 14 had the same inside residual tensile stress CT of 28.1 (MPa), Sample No. 13 was cut at a laser output of 80 (W), and Sample No. 14 was cut at a laser output of 90 (W). At this time, Sample No. 14 could be cut along the designed cut line, but Sample No. 13 could not be cut along the designed cut line.

In addition, Sample Nos. 15 and 16 had the same inside residual tensile stress CT of 37.7 (MPa), Sample No. 15 was cut at a laser output of 90 (W), and Sample No. 16 was cut at a laser output of 100 (W). At this time, Sample No. 16 could be cut along the designed cut line, but Sample No. 15 could not be cut along the designed cut line. Similarly, Sample Nos. 17 and 18 had the same inside residual tensile stress CT of 46.7 (MPa), Sample No. 17 was cut at a laser output of 130 (W), and Sample No. 18 was cut at a laser output of 140 (W). At this time, Sample No. 18 could be cut along the designed cut line, but Sample No. 17 could not be cut along the designed cut line.

In addition, Sample Nos. 19 and 20 had the same inside residual tensile stress CT of 22.2 (MPa), Sample No. 19 was cut at a laser output of 40 (W), and Sample No. 20 was cut at a laser output of 50 (W). At this time, Sample No. 20 could be cut along the designed cut line, but Sample No. 19 could not be cut along the designed cut line. Similarly, Sample Nos. 21 and 22 had the same inside residual tensile stress CT of 28.1 (MPa), Sample No. 21 was cut at a laser output of 60 (W), and Sample No. 22 was cut at a laser output of 70 (W). At this time, Sample No. 22 could be cut along the designed cut line, but Sample No. 21 could not be cut along the designed cut line.

In addition, Sample Nos. 23 and 24 had the same inside residual tensile stress CT of 37.7 (MPa), Sample No. 23 was cut at a laser output of 70 (W), and Sample No. 24 was cut at a laser output of 80 (W). At this time, Sample No. 24 could be cut along the designed cut line, but Sample No. 23 could not be cut along the designed cut line. Similarly, Sample Nos. 25 and 26 had the same inside residual tensile stress CT of 46.7 (MPa), Sample No. 25 was cut at a laser output of 100 (W), and Sample No. 26 was cut at a laser output of 110 (W). At this time, Sample No. 26 could be cut along the designed cut line, but Sample No. 25 could not be cut along the designed cut line.

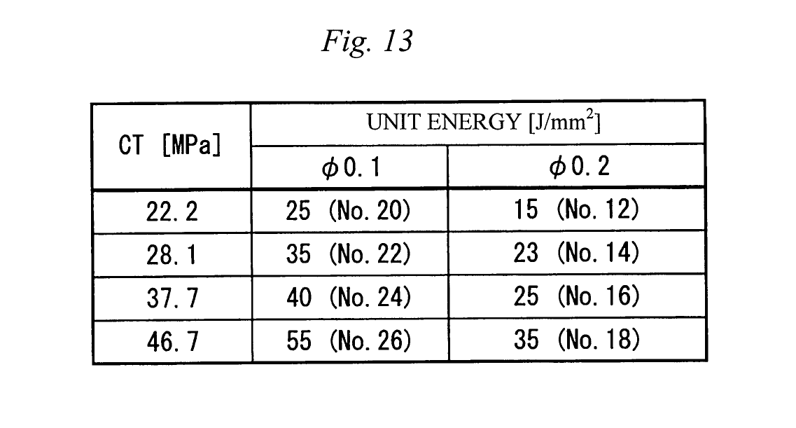

FIG. 13 is a table describing the relationship between the inside residual tensile stress CT (MPa) in the intermediate layer of the strengthened glass sheet and the irradiation energy (unit energy) E (J/mm²) per unit irradiation area of the laser beam necessary to cut the strengthened glass sheet. The table illustrated in FIG. 13 describes only the results of the tests described in FIG. 12 in which the strengthened glass sheet was successfully cut. Here, φ0.1 represents a beam diameter of 0.1 (mm), and φ0.2 represents a beam diameter of 0.2 (mm).

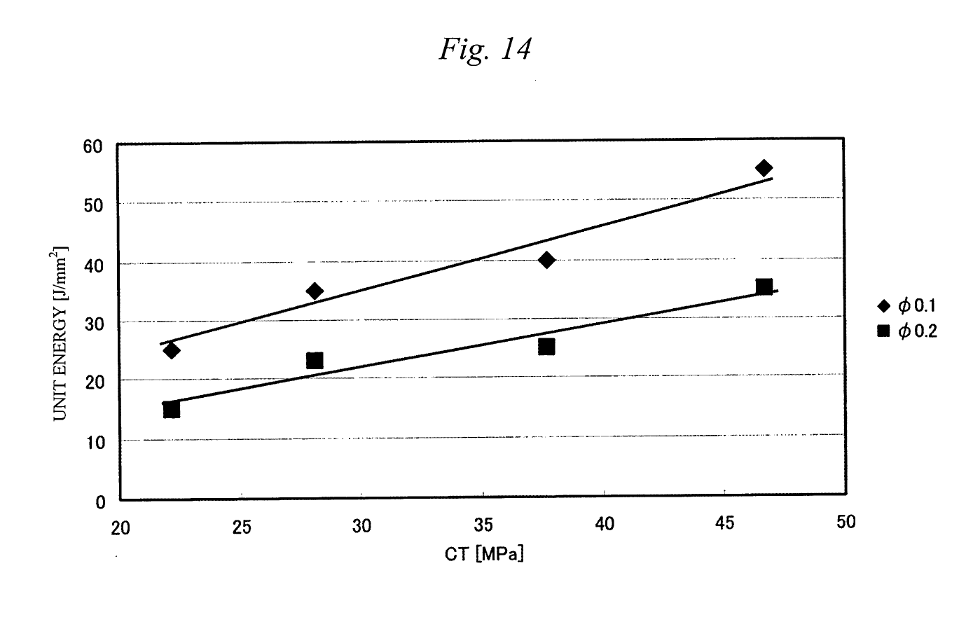

FIG. 14 is a graph illustrating the relationship between the inside residual tensile stress CT (MPa) in the intermediate layer in the strengthened glass sheet and the irradiation energy (unit energy) E (J/mm²) per unit irradiation area of the laser beam necessary to cut the strengthened glass sheet. FIG. 14 is a graph obtained by plotting the data described in FIG. 13. As described in FIGS. 13 and 14, the irradiation energy (unit energy) E (J/mm²) per unit irradiation area of the laser beam necessary to cut the strengthened glass sheet is dependent on the inside residual tensile stress CT (MPa). That is, it can be said that, as the inside residual tensile stress CT (MPa) increases, it is necessary to increase the unit energy E (J/mm²) of the laser beam necessary to cut the strengthened glass sheet. In addition, as the beam diameter decreases, a larger unit energy E is required.

### Example 3

Next, Example 3 of the invention will be described. In Example 3, the relationship between the scanning rate of the laser beam when cutting the strengthened glass sheet and the irradiation energy E (J/mm²) per unit irradiation area of the laser beam will be specifically described.

In Example 3, a strengthened glass sheet having a sheet thickness of 1.1 (mm), a surface compressive stress CS of 789 (MPa), a thickness DOL of each of the front surface layer and the rear surface layer of 36.6 (μm) and an inside residual tensile stress CT of 28.1 (MPa) was used.

The strengthened glass sheet was cut using the cutting method described in the embodiment. An initial crack was formed in advance in the cutting initiation location at an end portion of the strengthened glass sheet, but scribe lines were not formed on the surface of the strengthened glass sheet. A fiber laser (central wavelength band of 1070 nm) was used as the light source of the laser beam. In Example 3, the strengthened glass sheet was cut straightly from the cutting initiation location by a predetermined distance.

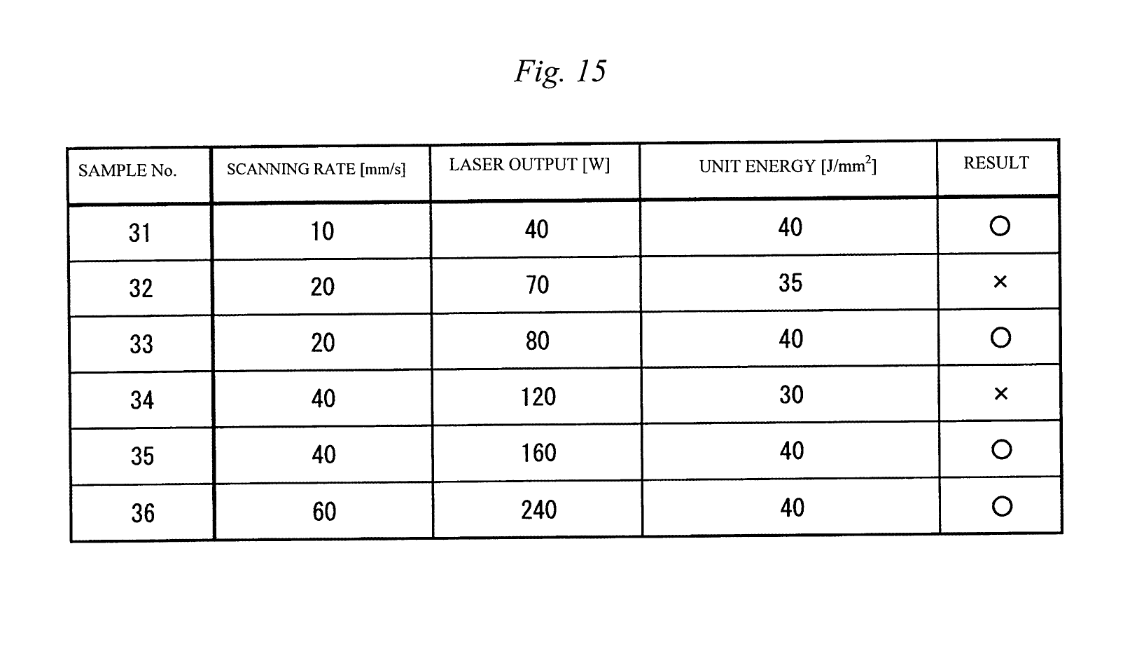

FIG. 15 describes the cutting conditions of the strengthened glass sheet and the cutting results. The table described in FIG. 15 shows the scanning rate (mm/s) of the laser beam, the laser output (W), and the irradiation energy E (J/mm²) per unit irradiation area of the laser beam as the conditions for cutting each of Sample Nos. 31 to 36. In Example 3, the beam diameters φ were all fixed to 0.1 (mm). In addition, the unit energy E (J/mm²) of the laser beam was obtained by substituting the laser output (W), the scanning rate (mm/s) of the laser beam, and the beam diameter φ (mm) into the above-described formula (1).

The cutting result was indicated as “O” in a case where the strengthened glass sheet could be cut along the designed cut line, and was indicated as “X” in a case where the extension of the crack could not be controlled and the crack ran off the designed cut line to cause deviant extension and in a case where the strengthened glass sheet could not be cut and the glass was crushed.

As described in the table in FIG. 15, in a case where the value of the unit energy E of the laser beam was 40 (J/mm²) (Sample Nos. 31, 33, 35 and 36), the strengthened glass sheet could be cut along the designed cut line. On the other hand, in a case where the value of the unit energy E of the laser beam was 30 (J/mm²) (Sample No. 34) or 35 (J/mm²) (Sample No. 32), the strengthened glass sheet could not be cut along the designed cut line.

From the results described in FIG. 15, it can be said that it is necessary to increase the laser output as the scanning rate of the laser beam increases. That is, when the scanning rate of the laser beam increases, the irradiation energy E per unit irradiation area of the laser beam decreases. Therefore, it is possible to suppress the decrease in the irradiation energy E per unit irradiation area of the laser beam by increasing the laser output in accordance with the increase in the scanning rate of the laser beam. At this time, when the value of the irradiation energy E per unit irradiation area of the laser beam is set to 40 (J/mm²) or more, it is possible to cut the strengthened glass sheet along the designed cut line. In other words, even in a case where the scanning rate of the laser beam is changed, it is possible to cut the strengthened glass sheet along the designed cut line by setting the value of the irradiation energy E per unit irradiation area of the laser beam to 40 (J/mm²) or more.

The invention has been described using the embodiment, but the invention is not limited to the configuration of the embodiment, and it is needless to say that the invention includes a variety of modifications, corrections and combinations that can be imagined by those skilled in the art within the scope of the claims.

The present application is based on Japanese Patent Application No. 2011-185833 filed on Aug. 29, 2011, and the content of which is incorporated herein by reference.

### DESCRIPTION OF REFERENCE NUMERALS AND SIGNS

10 STRENGTHENED GLASS SHEET
12 FRONT SURFACE
13 FRONT SURFACE LAYER
14 REAR SURFACE
15 REAR SURFACE LAYER
17 INTERMEDIATE LAYER
20 LASER BEAM
22 IRRADIATION REGION
31 CRACK
35 DESIGNED CUT LINE
40 SAMPLE SHAPE
41, 42, 43, 44 CORNER PORTION
45 CUTTING INITIATION LOCATION
46 CUTTING END LOCATION
51, 52, 53, 54 STRAIGHT PORTION
60 APPARATUS FOR CUTTING STRENGTHENED GLASS SHEET
61 LASER OUTPUT UNIT
62 GLASS HOLDING AND DRIVING UNIT
63 CONTROL UNIT
64 CONTROL PROGRAM-GENERATING UNIT

1. A method for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet,
wherein, in a case where the strengthened glass sheet is cut so as to have a predetermined curvature radius, an irradiation energy per unit irradiation area of the laser beam to be irradiated on the strengthened glass sheet is increased as the curvature radius decreases.

2. A method for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet,
wherein an irradiation energy per unit irradiation area of the laser beam to be irradiated on the strengthened glass sheet is increased as the inside residual tensile stress increases.

3. A method for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet,
wherein an output of the laser beam is increased as a moving rate of the irradiation region of the laser beam to be irradiated on the strengthened glass sheet increases.

4. The method for cutting a strengthened glass sheet according to claim 1, wherein the strengthened glass sheet is cut while suppressing extension of a crack caused in a rear part of the irradiation region in a scanning direction by heating the intermediate layer in the irradiation region of the laser beam at a temperature equal to or lower than an annealing point and generating a tensile stress or a compressive stress which is smaller than a value of the inside residual tensile stress, in the intermediate layer in the irradiation region.

5. The method for cutting a strengthened glass sheet according to claim 2, wherein the strengthened glass sheet is cut while suppressing extension of a crack caused in a rear part of the irradiation region in a scanning direction by heating the intermediate layer in the irradiation region of the laser beam at a temperature equal to or lower than an annealing point and generating a tensile stress or a compressive stress which is smaller than a value of the inside residual tensile stress, in the intermediate layer in the irradiation region.

6. The method for cutting a strengthened glass sheet according to claim 3, wherein the strengthened glass sheet is cut while suppressing extension of a crack caused in a rear part of the irradiation region in a scanning direction by heating the intermediate layer in the irradiation region of the laser beam at a temperature equal to or lower than an annealing point and generating a tensile stress or a compressive stress which is smaller than a value of the inside residual tensile stress, in the intermediate layer in the irradiation region.

7. The method for cutting a strengthened glass sheet according to claim 1, wherein, in a case where an absorption coefficient of the strengthened glass sheet with respect to the laser beam is represented by α (cm⁻¹) and a thickness of the strengthened glass sheet is represented by t (cm), the strengthened glass sheet and the laser beam satisfy a formula of 0<α×t≦3.0.

8. The method for cutting a strengthened glass sheet according to claim 2, wherein, in a case where an absorption coefficient of the strengthened glass sheet with respect to the laser beam is represented by α (cm⁻¹) and a thickness of the strengthened glass sheet is represented by t (cm), the strengthened glass sheet and the laser beam satisfy a formula of 0<α×t≦3.0.

9. The method for cutting a strengthened glass sheet according to claim 3, wherein, in a case where an absorption coefficient of the strengthened glass sheet with respect to the laser beam is represented by α (cm⁻¹) and a thickness of the strengthened glass sheet is represented by t (cm), the strengthened glass sheet and the laser beam satisfy a formula of 0<α×t≦3.0.

10. The method for cutting a strengthened glass sheet according to claim 1, wherein the irradiation energy per unit irradiation area of the laser beam is increased by decreasing a moving rate of the irradiation region of the laser beam.

11. The method for cutting a strengthened glass sheet according to claim 2, wherein the irradiation energy per unit irradiation area of the laser beam is increased by decreasing a moving rate of the irradiation region of the laser beam.

12. The method for cutting a strengthened glass sheet according to claim 1, wherein the irradiation energy per unit irradiation area of the laser beam is increased by increasing an output of the laser beam.

13. The method for cutting a strengthened glass sheet according to claim 2, wherein the irradiation energy per unit irradiation area of the laser beam is increased by increasing an output of the laser beam.

14. The method for cutting a strengthened glass sheet according to claim 1, wherein the irradiation energy per unit irradiation area of the laser beam is increased by decreasing an area of the irradiation region of the laser beam.

15. The method for cutting a strengthened glass sheet according to claim 2, wherein the irradiation energy per unit irradiation area of the laser beam is increased by decreasing an area of the irradiation region of the laser beam.

16. The method for cutting a strengthened glass sheet according to claim 7, wherein the irradiation energy per unit irradiation area of the laser beam is decreased as the adsorption coefficient α of the strengthened glass sheet increases.

17. The method for cutting a strengthened glass sheet according to claim 8, wherein the irradiation energy per unit irradiation area of the laser beam is decreased as the adsorption coefficient α of the strengthened glass sheet increases.

18. The method for cutting a strengthened glass sheet according to claim 9, wherein the irradiation energy per unit irradiation area of the laser beam is decreased as the adsorption coefficient α of the strengthened glass sheet increases.

19. The method for cutting a strengthened glass sheet according to claim 1, wherein the irradiation energy per unit irradiation area of the laser beam is decreased as a thermal expansion coefficient of the strengthened glass sheet increases.

20. The method for cutting a strengthened glass sheet according to claim 2, wherein the irradiation energy per unit irradiation area of the laser beam is decreased as a thermal expansion coefficient of the strengthened glass sheet increases.

21. The method for cutting a strengthened glass sheet according to claim 3, wherein the irradiation energy per unit irradiation area of the laser beam is decreased as a thermal expansion coefficient of the strengthened glass sheet increases.

22. The method for cutting a strengthened glass sheet according to claim 1, wherein the irradiation energy per unit irradiation area of the laser beam is increased as a thickness of the strengthened glass sheet increases.

23. The method for cutting a strengthened glass sheet according to claim 2, wherein the irradiation energy per unit irradiation area of the laser beam is increased as a thickness of the strengthened glass sheet increases.

24. The method for cutting a strengthened glass sheet according to claim 3, wherein the irradiation energy per unit irradiation area of the laser beam is increased as a thickness of the strengthened glass sheet increases.

25. An apparatus for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet, the apparatus comprising:
a glass holding and driving unit which holds the strengthened glass sheet and moves the strengthened glass sheet in a predetermined direction;
a laser output unit which outputs a laser beam for cutting the strengthened glass sheet;
a control unit which controls the glass holding and driving unit and the laser output unit based on a control program; and
a control program-generating unit which generates the control program,
wherein the control program-generating unit generates a control program which controls an area of the irradiation region of the laser beam, an output of the laser beam and a moving rate of the irradiation region of the laser beam in accordance with a curvature radius in a designed cut line for the strengthened glass sheet.
